(19) United States
(12) Patent Application Publication
(10) Pub. No.: US 2021/0173236 A1
(43) Pub. Date: Jun. 10, 2021

(54) METHOD FOR MANUFACTURING OPTICAL SEMICONDUCTOR ELEMENT, AND OPTICAL SEMICONDUCTOR ELEMENT

(71) Applicant: Mitsubishi Electric Corporation, Chiyoda-ku, Tokyo (JP)

(72) Inventors: Keigo FUKUNAGA, Chiyoda-ku, Tokyo (JP); Yuichiro HORIGUCHI, Chiyoda-Ku, Tokyo (JP); Kazuhiro MAEDA, Chiyoda-Ku, Tokyo (JP); Daisuke TSUNAMI, Chiyoda-Ku, Tokyo (JP)

(73) Assignee: Mitsubishi Electric Corporation, Chiyoda-ku, Tokyo (JP)

(21) Appl. No.: 16/616,805

(22) PCT Filed: Aug. 1, 2018
(86) PCT No.: PCT/JP2018/028800

§ 371 Date: Nov. 25, 2019

(30) Foreign Application Priority Data
Aug. 1, 2017 (JP) 2017-149325

(51) Int. Cl. G02F 1/025

(52) U.S. Cl. CPC G02F 1/025

(57) ABSTRACT

The present invention includes a step for depositing an active layer, a cladding layer, and a contact layer on a semiconductor substrate, a step for etching the layers to form a mesa structure, a step for forming an insulation film to cover the mesa structure, a step for reducing the thickness of the insulation film until the top surface of the contact layer is exposed and using the remaining insulation film as a side wall, a step for forming a dielectric resin layer and burying the mesa structure and the side wall, a step for selectively etching the dielectric resin layer to form an opening and causing the top surface of the contact layer to be exposed, and a step for forming an electrode in the opening.

### TECHNICAL FIELD

The present invention relates to a method for manufacturing an optical semiconductor element and an optical semiconductor element, and more particularly to a method for manufacturing an optical semiconductor element used in a Mach-Zehnder optical modulator and the optical semiconductor element used therein.

### BACKGROUND ART

FIG. 20 is a cross-sectional view of an optical semiconductor element, generally indicated by 500, used in a conventional Mach-Zehnder optical modulator. The optical semiconductor element 500 includes a mesa structure 12 composed of an active layer 9, a cladding layer 10, and a contact layer 11, being provided on a semiconductor substrate 1. An insulating film 28 is formed on a front surface of the semiconductor substrate 1 and a side surface of the mesa structure 12, and the mesa structure 12 is provided on its both sides with a dielectric resin layer 14 enclosed. An insulating film 15 is formed on the dielectric resin layer 14. Then, the insulating film 15 on the contact layer 11 is opened, and an electrode 16 electrically connected to the contact layer 11 is provided.

In a step of manufacturing the optical semiconductor element 500, as illustrated in FIG. 21, a cap layer 24 is formed on the contact layer 11 of the mesa structure 12, and the insulating film 28 and the dielectric resin layer 14 are formed for covering the mesa structure 12 and the cap layer. Subsequently, a resist mask 25 is formed on the dielectric resin layer 14.

Next, as illustrated in FIG. 22, the insulating film 28 and the dielectric resin layer 14 are etched using the resist mask 25 as an etching mask. At this time, the cap layer 24 has a width W2 narrower than a width W1 of the mesa structure 12. Thus, stopping etching when the upper surface of the cap layer 24 is exposed, as a guideline, prevents over-etching of the insulating film 28 on the side surface of the mesa structure 12 and the dielectric resin layer 14 as illustrated in FIG. 23, i.e., peeling of the dielectric resin layer 14 (e.g., refer to Patent Document 1).

### PRIOR ART DOCUMENTS

### Patent Documents

Patent Document 1: JP 2013-44793 A

### SUMMARY OF THE INVENTION

### Problems to be Solved by the Invention

Unfortunately, while the conventional manufacturing method described above requires detecting a point (etching stop point) at which the upper surface of the cap layer 24 is exposed during etching using change in emission intensity of ions or radicals, for example, the upper surface of the cap layer 24 has an extremely small area compared to an area of the semiconductor substrate 1. Thus, the emission intensity of ions and the like is also small, so that it is difficult to detect the etching stop point using change in the emission intensity.

Then, it is an object of the present invention to provide a method for manufacturing an optical semiconductor element and an optical semiconductor element, preventing peeling of the dielectric resin layer from a mesa structure without requiring detecting an etching state.

### Means for Solving the Problems

The present invention is a method for manufacturing an optical semiconductor element, the method including: a step of preparing a semiconductor substrate; a step of sequentially depositing an active layer, a cladding layer, and a contact layer on the semiconductor substrate; a step of etching the active layer, the cladding layer, and the contact layer to form a mesa structure in which the active layer, the cladding layer, and the contact layer are layered on the semiconductor substrate; a step of forming an insulating film on the semiconductor substrate to cover the mesa structure; a step of reducing the insulating film in thickness until an upper surface of the contact layer is exposed to use the insulating film left on a side surface of the mesa structure as a sidewall; a step of forming a dielectric resin layer on the semiconductor substrate to enclose the mesa structure and the sidewall; a first opening step of selectively etching the dielectric resin layer to form a first opening and expose the upper surface of the contact layer in the first opening; and a step of forming an electrode to connect to the contact layer.

The present invention is an optical semiconductor element including: a semiconductor substrate; a mesa structure formed on the semiconductor substrate with an active layer, a cladding layer, and a contact layer being layered; a sidewall covering a side surface of the mesa structure; a dielectric resin layer formed on the semiconductor substrate for enclosing the sidewall, the dielectric resin layer having a first opening exposing an upper surface of the contact layer; and an electrode provided connected to the contact layer.

### Effects of the Invention

The method for manufacturing an optical semiconductor element according to the present invention enables preventing peeling of the dielectric resin layer from the side surface of the mesa structure without detecting the etching stop point, so that a yield can be improved.

The optical semiconductor element according to the present invention does not allow a surface of the dielectric resin layer that is easily etched to be exposed, so that peeling and deterioration of the dielectric resin layer can be prevented to enable obtaining a highly reliable optical semiconductor element.

### BRIEF DESCRIPTION OF THE DRAWINGS

FIG. 1 is a plan view of a Mach-Zehnder optical modulator according to a first embodiment of the present invention.

FIG. 2 is a cross-sectional view of an optical semiconductor element when the Mach-Zehnder optical modulator of FIG. 1 is taken along line II-II.

FIG. 3 is a cross-sectional view of an optical semiconductor element according to a first embodiment of the present invention in a manufacturing step.

FIG. 4 is a cross-sectional view of the optical semiconductor element according to the first embodiment of the present invention in a manufacturing step.

FIG. 5 is a cross-sectional view of the optical semiconductor element according to the first embodiment of the present invention in a manufacturing step.

FIG. 6 is a cross-sectional view of the optical semiconductor element according to the first embodiment of the present invention in a manufacturing step.

FIG. 7 is a cross-sectional view of the optical semiconductor element according to the first embodiment of the present invention in a manufacturing step.

FIG. 8 is a cross-sectional view of the optical semiconductor element according to the first embodiment of the present invention in a manufacturing step.

FIG. 9 is a cross-sectional view of the optical semiconductor element according to the first embodiment of the present invention in a manufacturing step.

FIG. 10 is a cross-sectional view of the optical semiconductor element according to the first embodiment of the present invention in a manufacturing step.

FIG. 11 is a cross-sectional view of the optical semiconductor element according to the first embodiment of the present invention in a manufacturing step.

FIG. 12 is a cross-sectional view of the optical semiconductor element according to the first embodiment of the present invention in a manufacturing step.

FIG. 13 is a cross-sectional view of the optical semiconductor element according to the first embodiment of the present invention in a manufacturing step.

FIG. 14 is a cross-sectional view of the optical semiconductor element according to the first embodiment of the present invention in a manufacturing step.

FIG. 15 is a cross-sectional view of the optical semiconductor element according to the first embodiment of the present invention in a manufacturing step.

FIG. 16 is a cross-sectional view of an optical semiconductor element according to a second embodiment of the present invention.

FIG. 17 is a cross-sectional view of the optical semiconductor element according to the second embodiment of the present invention in a manufacturing step.

FIG. 18 is a cross-sectional view of the optical semiconductor element according to the second embodiment of the present invention in a manufacturing step.

FIG. 19 is a cross-sectional view of the optical semiconductor element according to the second embodiment of the present invention in a manufacturing step.

FIG. 20 is a cross-sectional view of an optical semiconductor element of a conventional Mach-Zehnder optical modulator.

FIG. 21 is a cross-sectional view of a conventional optical semiconductor element in a manufacturing step.

FIG. 22 is a cross-sectional view of the conventional optical semiconductor element in a manufacturing step.

FIG. 23 is a cross-sectional view of the conventional optical semiconductor element in a manufacturing step.

### EMBODIMENTS OF THE INVENTION

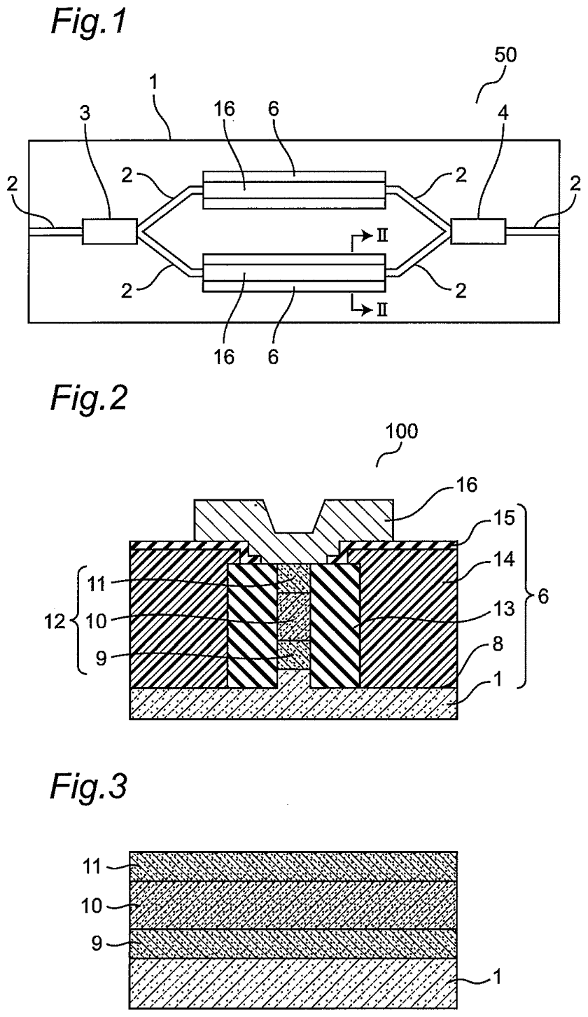

FIG. 1 is a plan view of a Mach-Zehnder optical modulator according to a first embodiment of the present invention, generally indicated by 50. The Mach-Zehnder optical modulator 50 has a semiconductor substrate 1. On the semiconductor substrate 1, a demultiplexer 3, a multiplexer 4, and two phase modulation regions 6 are provided. The demultiplexer 3, the multiplexer 4, and the phase modulation region 6 are connected with optical waveguides 2 interposed therebetween. The demultiplexer 3 and the multiplexer 4 are each composed of a multi-mode interference (MMI) coupler, for example.

The phase modulation regions 6 are each provided with an electrode 16 for modulating a phase of light to constitute an optical semiconductor element (refer to FIG. 2).

In the optical modulator 50, light incident from the optical waveguide 2 on one side is demultiplexed by the demultiplexer 3 to travel into two of the optical waveguides 2. The demultiplexed light passes through each of the phase modulation regions 6, and is then multiplexed by the multiplexer 4 to be emitted from the optical waveguide 2 on the other side. In each of the phase modulation regions 6, the electrode 16 modulates the phase of light. For example, when light emitted from each of the two phase modulation regions 6 has the same phase, output of the light multiplexed by the multiplexer 4 increases. When light emitted from each of the two phase modulation regions 6 has an opposite phase, output of the light multiplexed by the multiplexer 4 is zero.

FIG. 2 is a cross-sectional view of an optical semiconductor element generally indicated by 100 when the Mach-Zehnder optical modulator 50 of FIG. 1 is taken along line II-II.

The optical semiconductor element 100 includes the semiconductor substrate 1 made of n-type InP, for example. The semiconductor substrate 1 is provided, on a front surface 8, with a mesa structure 12 in which an active layer 9, a cladding layer 10, and a contact layer 11 are layered. The optical waveguide 2 of the optical modulator 50 includes the mesa structure 12.

The mesa structure 12 is formed on both sides with sidewall 13. For the sidewall 13, an inorganic material made of a silicon-based compound such as SiN or SiO₂ is used, for example. It is desirable to design a width of the sidewall 13 in consideration of positional accuracy of an etching mask formed by photolithography technique and the amount of side etching generated when a dielectric resin layer 14 is opened. While even in the prior art, an insulating film being a silicon-based compound portion is provided on a sidewall of a mesa structure, the sidewall has a width of 0.5 μm or less in many cases. In contrast, the sidewall 13 desirably has a width of 0.5 μm or more.

The outside of the sidewall 13 is enclosed by the dielectric resin layer 14. For the dielectric resin layer 14, an organic material such as benzocyclobutene (BCB) is used, for example. The dielectric resin layer 14 has an upper surface at a height higher than a height of the mesa structure 12, and a part of the dielectric resin layer 14 extends to the upper surface of the sidewall 13.

The dielectric resin layer 14 has a front surface covered with a second insulating film 15. For the second insulating film 15, an inorganic material made of a silicon compound such as SiN or SiO₂ is used, for example. The second insulating film 15 extends onto the sidewall 13 while the front surface of the dielectric resin layer 14 is covered therewith. The second insulating film 15 has an opening that exposes an upper portion of the mesa structure 12. Forming the second insulating film 15 enables suppressing deterioration of the dielectric resin layer and improving adhesion to the electrode.

The electrode 16 is provided for filling the opening. The electrode 16 is made of Ti/Pt/Au, for example. The electrode 16 is formed on the upper portion of the mesa structure 12 for filling the opening, and is in contact with the contact layer 11 and the sidewall 13 on both sides across the mesa structure 12. When the electrode 16 is formed for being in contact with not only the contact layer 11 but also the sidewall 13 on both the sides across the mesa structure 12, the entire upper surface of the contact layer 11 is in contact with the electrode 16 to enable decrease in contact resistance.

Next, a method for manufacturing the optical semiconductor element 100 according to the first embodiment of the present invention will be described with reference to FIGS. 3 to 15. The method for manufacturing the optical semiconductor element 100 includes the following steps 1 to 14. FIGS. 3 to 15 are each a cross-sectional view in a manufacturing step, and in the drawings, the same reference numerals as in FIG. 2 indicate the same or corresponding portions.

Step 1: As illustrated in FIG. 3, first, the semiconductor substrate 1 made of n-type InP, for example, is prepared. The active layer 9, the cladding layer 10, and the contact layer 11 are sequentially allowed to develop epitaxial growth on the semiconductor substrate 1. The active layer 9 is composed of an undoped semiconductor such as AlGaInAs, for example, and may be a single layer or may have a quantum well structure. The cladding layer 10 is made of p-type InP, for example. The contact layer 11 is made of p-type InGaAs, for example. As a growth method, metal organic chemical vapor deposition (MOCVD) is used, for example.

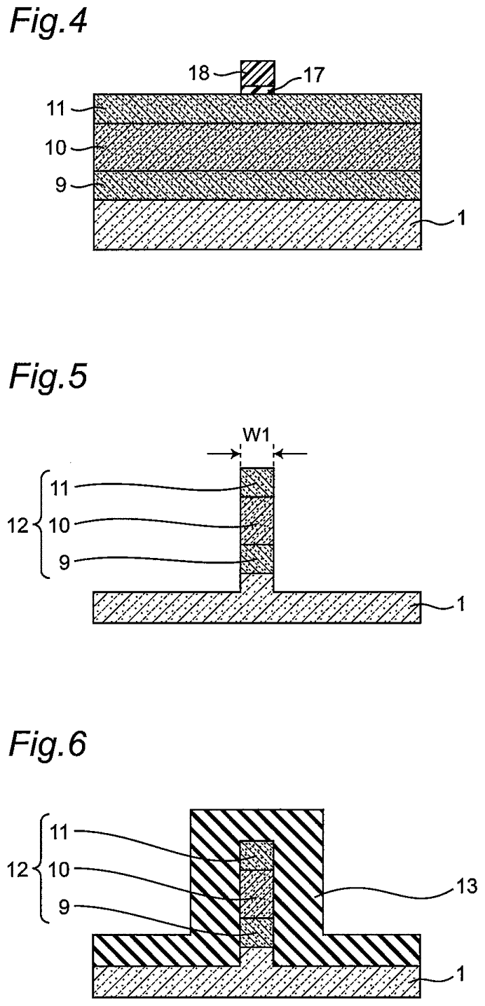

Step 2: As illustrated in FIG. 4, an insulating film made of SiO₂ is formed on the contact layer 11 by using a CVD method, for example, and a resist mask 18 is formed on the insulating film. Subsequently, the insulating film is dry etched using the resist mask 18 as an etching mask to form an etching mask 17. After the etching mask 17 is formed, the resist mask 18 is removed using a chemical solution.

Step 3: As illustrated in FIG. 5, the contact layer 11, the cladding layer 10, and the active layer 9 are etched using the etching mask 17 to form the mesa structure 12. As illustrated in FIG. 5, a part of the semiconductor substrate 1 may be etched. The mesa structure 12 has a width (length in the lateral direction in FIG. 5) W1 of 2.0 μm and a height of 4.0 μm, for example. For dry etching, it is preferable to use plasma etching such as reactive ion etching (RIE), for example.

After the mesa structure 12 is formed, the etching mask 17 is removed using a chemical solution.

Step 4: As illustrated in FIG. 6, an insulating film constituting the sidewall 13 is entirely formed on the surface. The insulating film is made of SiN, for example, and is formed by the CVD method. The insulating film is preferably made of a material capable of suppressing deterioration due to oxidation of the active layer 9 exposed to the side surface of the mesa structure 12.

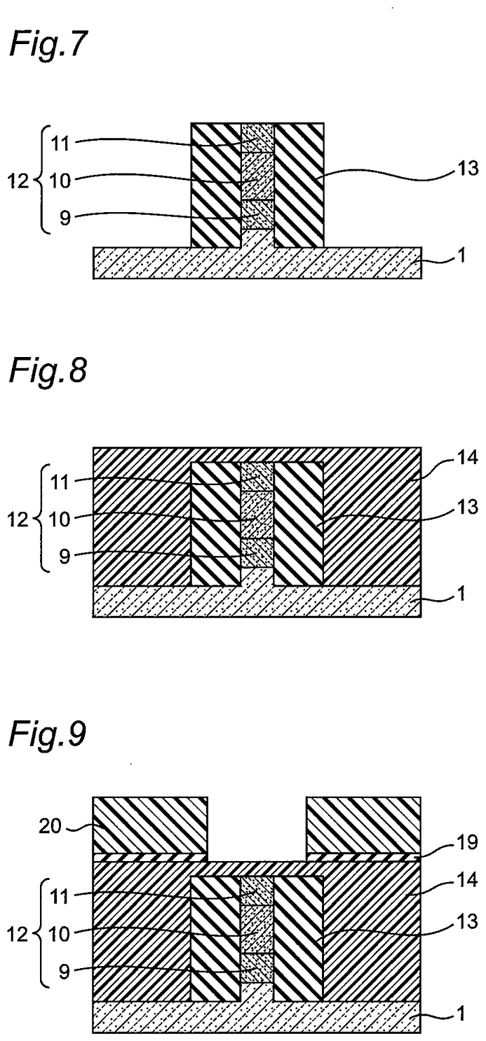

Step 5: As illustrated in FIG. 7, the insulating film is left on both sides across the mesa structure 12 by dry etching throughout the insulating film on the semiconductor substrate 1 without forming an etching mask to form the sidewall 13. It is necessary to design a film thickness of the sidewall 13 in a direction (lateral direction in FIG. 7) intersecting the mesa structure 12 in consideration of processing accuracy such as mask alignment accuracy of an exposure device, and the amount of side etching. For example, when the mesa structure 12 has a width W1 of 2.0 μm, the etching mask 17 on the mesa structure 12 has a width of 2.2 μm, the exposure device has a mask alignment accuracy of ±0.5 μm, and the amount of side etching is +0.1 μm, the sidewall 13 has a film thickness of 0.7 μm or more. The sidewall 13 may be formed of a plurality of dielectric materials.

Step 6: As illustrated in FIG. 8, the dielectric resin layer 14 is formed to enclose the mesa structure 12 and the sidewall 13. The dielectric resin layer 14 is made of BCB, for example, and the BOB is applied by spin coating, for example, to have a height more than heights of the mesa structure 12 and the sidewall 13.

After that, heat treatment is performed to cure the BCB. When BCB resin being a low dielectric material is used as the material of the dielectric resin layer 14, parasitic capacitance between the electrode 16 and the semiconductor substrate 1 can be reduced to improve high frequency characteristics.

Step 7: As illustrated in FIG. 9, an etching mask 19 for exposing the upper portion of the mesa structure 12 is formed. The etching mask 19 is formed by first forming an insulating film made of SiO₂, for example, on the dielectric resin layer 14 with a plasma CVD method. Next, a resist mask 20 is formed on the insulating film by photolithography technique. The insulating film is dry etched using the resist mask 20 to form the etching mask 19. After the etching mask 19 is formed, the resist mask 20 is removed using a chemical solution.

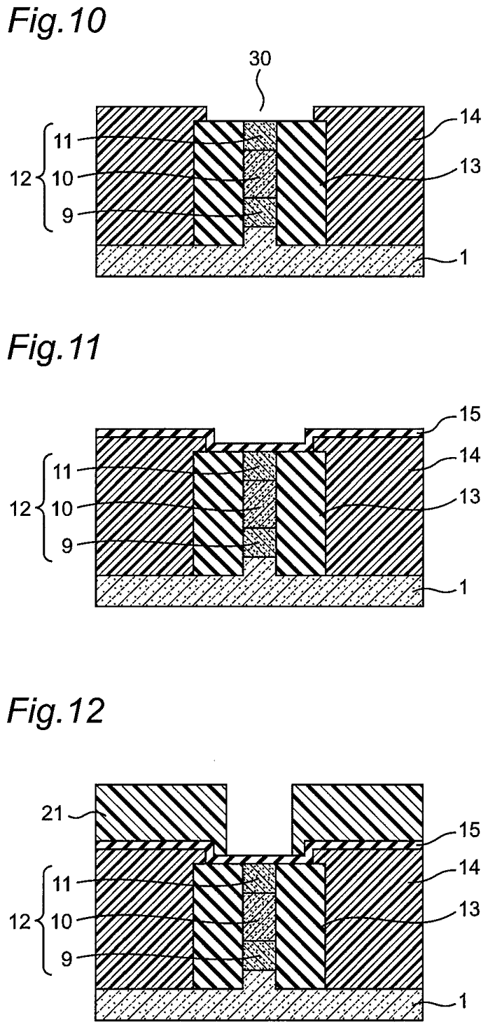

Step 8: As illustrated in FIG. 10, the dielectric resin layer 14 is dry etched using the etching mask 19 to expose upper portions of the mesa structure 12 and the sidewall 13. The dielectric resin layer 14 has an opening 30 with a width wider than the width W1 of the mesa structure 12, and the opening 30 of the dielectric resin layer 14 is formed having an edge positioned above the sidewall 13. After the opening 30 is formed in the dielectric resin layer 14, the etching mask 19 is removed using a chemical solution. Dry etching may be used to remove the etching mask 19.

Step 9: As illustrated in FIG. 11, the second insulating film 15 is formed for covering the mesa structure 12, the sidewall 13, and the dielectric resin layer 14. For example, SiO₂ is used as a material of the second insulating film 15 and is formed by a plasma CVD method or the like.

Step 10: As illustrated in FIG. 12, a resist mask 21 is formed by photolithography technique.

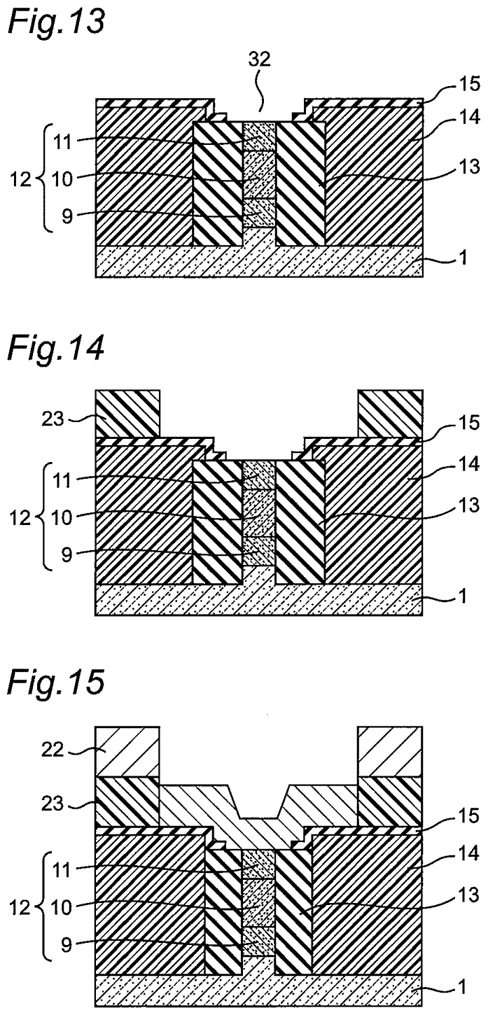

Step 11: As illustrated in FIG. 13, the second insulating film 15 on the upper portion of the mesa structure 12 is removed by dry etching using the resist mask 21 to form an opening 32. The opening 32 of the second insulating film 15 has a width wider than the width W1 of the mesa structure 12. The opening 32 of the second insulating film has an edge in contact with an upper portion of the sidewall 13. When the edge of the opening 32 of the second insulating film 15 is not in contact with the upper portion of the sidewall 13, and is in contact with the upper portion of the mesa structure 12, a contact area between the contact layer and the electrode decreases, causing a problem of increased resistance. When the edge of the opening 32 comes into contact with the upper portion of the sidewall 13, a good contact can be obtained between the contact layer 11 and the electrode. In addition, the dielectric resin layer 14 can be covered with the second insulating film 15, so that etching of the dielectric resin layer 14 during a processing step of the second insulating film 15 and subsequent steps can be prevented. Thus peeling of the dielectric resin layer 14 from the mesa structure 12 can be prevented. After the opening 32 of the second insulating film 15 is formed, the resist mask 21 is removed using a chemical solution.

Step 12: As illustrated in FIG. 14, a resist mask 23 is formed on the second insulating film 15 by photolithography technique.

Step 13: As illustrated in FIG. 15, a metal layer 22 is entirely formed on the surface. The metal layer 22 also comes into contact with the mesa structure 12 and the sidewall 13. For forming the metal layer 22, a vacuum evaporation method or a sputtering method can be used, for example. As a material of the metal layer 22, Ti/Pt/Au can be used, for example.

Step 14: The resist mask 23 is removed using a chemical solution, and the metal layer 22 on the resist mask 23 is removed by a lift-off method. The remaining metal layer 22 serves as the electrode 16.

Through the above steps, the optical semiconductor element 100 according to the first embodiment of the present invention illustrated in FIG. 2 is completed.

The method for manufacturing the optical semiconductor element 100 according to the first embodiment of the present invention includes a step of forming the opening 30 by etching the dielectric resin layer 14 (refer to step 8 and FIG. 10). In the step, even when a sufficient etching time is provided (even when over-etching is performed) in consideration of variations in film thickness from the upper portion of the dielectric resin layer 14 to the upper portion of the mesa structure 12, the sidewall 13 causes the etching of the dielectric resin layer 14 to proceed in the direction intersecting the mesa structure 12 (lateral direction in FIG. 10) after the dielectric resin layer 14 in a range from the upper portion of the dielectric resin layer 14 to the upper portion of the mesa structure 12 is removed. That is, decrease in contact area between the sidewall 13 and the dielectric resin layer 14 can be prevented to prevent the sidewall 13 and the dielectric resin layer 14 from peeling off from the mesa structure 12.

As described above, even when a conventional etching stop point is not separately detected, the dielectric resin layer 14 is not etched and peeled off from the sidewall 13.

The opening 30 of the dielectric resin layer 14 has a width wider than the width W1 of the mesa structure 12, and the opening 30 of the dielectric resin layer 14 is formed having an edge positioned above the sidewall 13 (refer to FIG. 10). Accordingly, the contact layer 11 in the upper portion of the mesa structure 12 can be completely exposed, so that the entire upper surface of the contact layer 11 can be in contact with the electrode 16 to reduce contact resistance.

### Second Embodiment

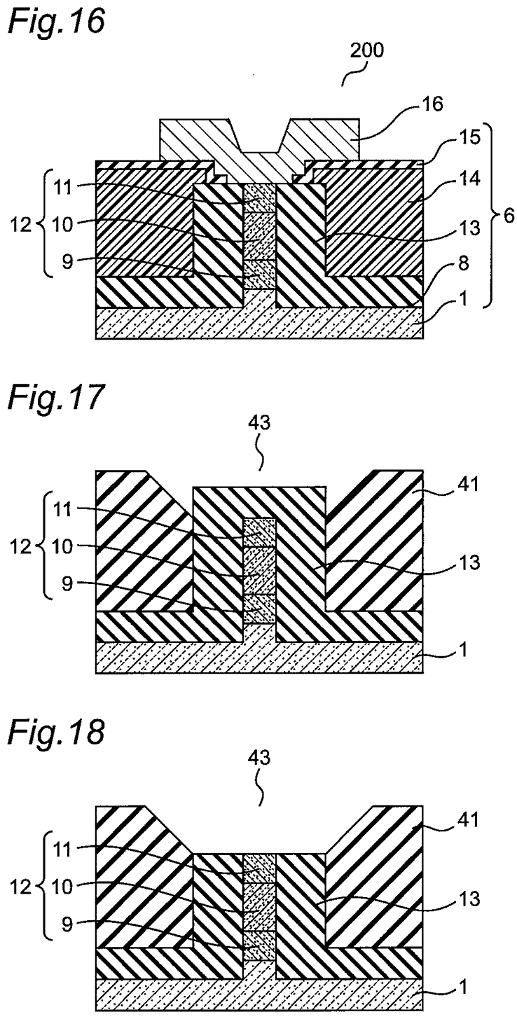

FIG. 16 is a cross-sectional view of an optical semiconductor element according to a second embodiment of the present invention, generally indicated by 200. The same reference numerals as in FIG. 2 indicate the same or corresponding portions. In the optical semiconductor element 200 according to the second embodiment of the present invention, a sidewall 13 composed of an insulating film extends also onto a front surface 8 of a semiconductor substrate 1. The other structure is the same as that of the optical semiconductor element 100 according to the first embodiment.

Next, a method for manufacturing the optical semiconductor element 200 will be described with reference to FIGS. 17 to 19. FIGS. 17 to 19 are each a cross-sectional view of the optical semiconductor element 200 according to the second embodiment of the present invention in a manufacturing step. In FIGS. 17 to 19, the same reference numerals as in FIG. 2 indicate the same or corresponding portions.

In the manufacturing method according to the second embodiment of the present invention, the following steps “a” to “c” (FIGS. 17 to 19) are performed after steps 1 to 4 (FIGS. 3 to 6) of the first embodiment.

Step “a”: As illustrated in FIG. 17, an insulating film 41 is formed on the sidewall 13 subsequent to step 4 (FIG. 6). The insulating film 41 is made of SiO₂, for example. At this time, the sidewall 13 remains on a front surface of the semiconductor substrate 1. Subsequently, the insulating film 41 is etched using a resist mask (not illustrated) to form an opening 43. In the opening 43, an upper portion of the sidewall 13 is exposed.

While the sidewall 13 is left also on the front surface of the semiconductor substrate 1 here, an insulating film may be separately formed after the sidewall 13 on the semiconductor substrate 1 is once removed, as illustrated in FIG. 7.

Step “b”: As illustrated in FIG. 18, the sidewall 13 exposed in the opening 43 is etched using the insulating film 41 as an etching mask to expose upper portions of the contact layer 11 of the mesa structure 12 and the sidewall 13.

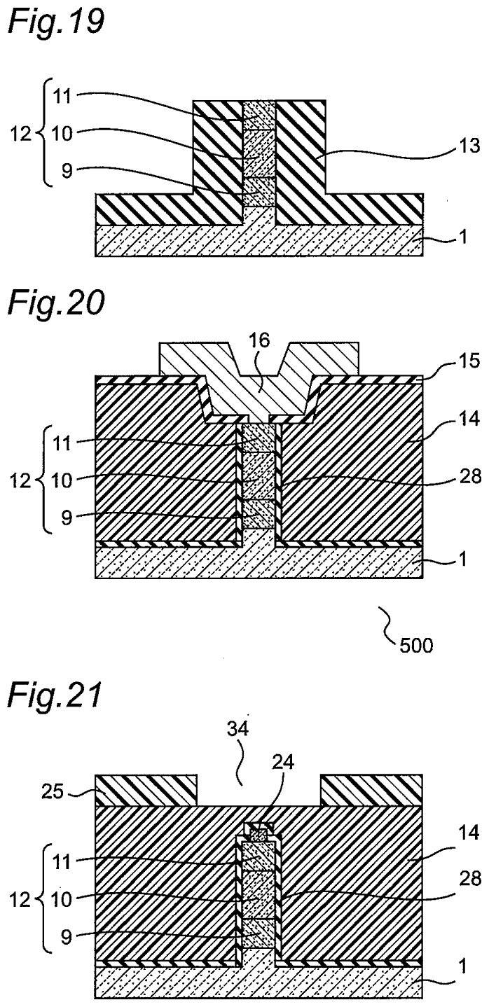

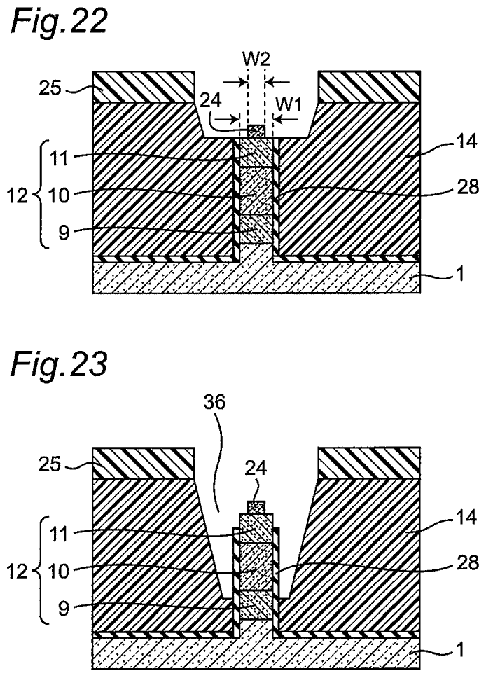

Step “c”: As illustrated in FIG. 19, the insulating film 41 is selectively removed to expose the sidewall 13.

Subsequent to step “c”, steps 6 to 14 (FIGS. 8 to 15) of the first embodiment are performed to complete the optical semiconductor element 200 according to the second embodiment of the present invention illustrated in FIG. 16.

In the optical semiconductor element 200 according to the second embodiment of the present invention, for example, the sidewall 13 composed of the insulating film extends onto not only the side wall of the mesa structure 12 but also the front surface 8 of the semiconductor substrate 1 as illustrated in FIG. 16, so that the dielectric resin layer 14 and the semiconductor substrate 1 are not in contact with each other. Accordingly, the dielectric resin layer 14 and the sidewall 13 come into contact with each other to improve adhesion therebetween, so that peeling of the dielectric resin layer 14 can be further prevented.

While in the first and second embodiments, the structure having the second insulating film 15 on the dielectric resin layer 14 is described as an example, structure without the second insulating film 15 may be used, and the present invention is not limited to the structure described in the first and second embodiments.

### DESCRIPTION OF REFERENCE SYMBOLS

1 SEMICONDUCTOR SUBSTRATE
2 OPTICAL WAVEGUIDE
3 DEMULTIPLEXER
4 MULTIPLEXER
6 PHASE MODULATION REGION
8 FRONT SURFACE
9 ACTIVE LAYER
10 CLADDING LAYER
11 CONTACT LAYER
12 MESA STRUCTURE
13 SIDEWALL
14 DIELECTRIC RESIN LAYER
15 SECOND INSULATING FILM
16 ELECTRODE
17 ETCHING MASK
18 RESIST MASK
19 ETCHING MASK
20 RESIST MASK
21 RESIST MASK
22 METAL LAYER
23 RESIST MASK
30 OPENING
50 MACH-ZEHNDER OPTICAL MODULATOR
100 OPTICAL SEMICONDUCTOR ELEMENT

1. A method for manufacturing an optical semiconductor element, the method comprising:
a step of preparing a semiconductor substrate;
a step of sequentially depositing an active layer, a cladding layer, and a contact layer on the semiconductor substrate;
a step of etching the active layer, the cladding layer, and the contact layer to form a mesa structure in which the active layer, the cladding layer, and the contact layer are layered on the semiconductor substrate;
a step of forming an insulating film on the semiconductor substrate to cover the mesa structure;
a step of reducing the insulating film in thickness until an upper surface of the contact layer is exposed to use the insulating film left on a side surface of the mesa structure as a sidewall;
a step of forming a dielectric resin layer on the semiconductor substrate to enclose the mesa structure and the sidewall;
a first opening step of selectively etching the dielectric resin layer to form a first opening and expose the upper surface of the contact layer in the first opening; and
a step of forming an electrode to connect to the contact layer.

2. The method according to claim 1, further comprising:
a step of forming a second insulating film on the semiconductor substrate to cover an inner surface of the first opening and the dielectric resin layer after the first opening step; and
a second opening step of selectively etching the second insulating film to form a second opening, and exposing the upper surface of the contact layer in the second opening.

3. The method according to claim 1 or 2, wherein
the first opening has a width wider than a width of the mesa structure, and
the first opening step is a step of etching the dielectric resin layer allowing an opening edge of the dielectric resin layer to be positioned on the sidewall.

4. The method according to claim 2, wherein
the second opening has a width wider than a width of the mesa structure, and
the second opening step is a step of etching the insulating film allowing an opening edge of the insulating film to be positioned on the sidewall.

5. An optical semiconductor element comprising:
a semiconductor substrate;
a mesa structure formed on the semiconductor substrate, with an active layer, a cladding layer, and a contact layer being layered;
a sidewall covering a side surface of the mesa structure, and exposing an upper surface of the contact layer;
a dielectric resin layer formed on the semiconductor substrate for enclosing the sidewall, the dielectric resin layer having a first opening exposing an upper surface of the contact layer, the first opening having a width wider than a width of the mesa structure, and the first opening having an opening edge positioned on a front surface of the sidewall;
an insulating film covering the sidewall and the dielectric resin layer, and having a second opening exposing the upper surface of the contact layer, the second opening having a width wider than a width of the mesa structure, and the second opening having an opening edge positioned on a front surface of the sidewall; and
an electrode provided connected to the contact layer.

6-8. (canceled)

9. An optical semiconductor element comprising:
a semiconductor substrate;
a mesa structure formed on the semiconductor substrate, with an optical waveguide active layer, a cladding layer, and a contact layer being layered;
a sidewall covering a side surface of the mesa structure, exposing an upper surface of the contact layer, and extending onto a front surface of the semiconductor substrate;
a dielectric resin layer formed on the semiconductor substrate for enclosing the sidewall, the dielectric resin layer having a first opening exposing an upper surface of the contact layer, the first opening having a width wider than a width of the mesa structure, and the first opening having an opening edge positioned on a front surface of the sidewall;
an insulating film covering the sidewall and the dielectric resin laver, and having a second opening exposing the upper surface of the contact layer, the second opening having a width wider than a width of the mesa structure, and the second opening having an opening edge positioned on a front surface of the sidewall; and
an electrode provided connected to the contact layer.

10-11. (canceled)

12. An optical modulator comprising the optical semiconductor element according to claim 5.

13. An optical modulator comprising the optical semiconductor element according to claim 9.
